(19) United States
(12) Patent Application Publication
(10) Pub. No.: US 2025/0222399 A1
(43) Pub. Date: Jul. 10, 2025

(54) METHOD FOR SCRUBBING SULFURYL FLUORIDE FROM A FLUID

(71) Applicant: THE CONNECTICUT AGRICULTURAL EXPERIMENT STATION, New Haven, CT (US)

(72) Inventors: Joseph J. Pignatello, Hamden, CT (US); Chengjin Wang, Winnipeg, Manitoba (CA); Zhihao Chen, New Haven, CT (US)

(21) Appl. No.: 18/703,097

(22) PCT Filed: Oct. 28, 2022
(86) PCT No.: PCT/US2022/048164

§ 371 Date: Apr. 19, 2024

Related U.S. Application Data
(60) Provisional application No. 63/273,394, filed on Oct. 29, 2021.

(51) Int. Cl. B01D 53/68; B01D 53/14; B01D 53/78

(52) U.S. Cl. CPC B01D 53/68; B01D 53/1418; B01D 53/1493; B01D 53/78; B01D 2251/106; B01D 2251/402; B01D 2251/404; B01D 2257/204

(57) ABSTRACT

Method for scrubbing sulfuryl fluoride, which is accomplished by placing a fluid comprising sulfuryl fluoride in contact with an aqueous solution of a base and a peroxide having at least one—O—OH group. Also described is kit suitable for use with the sulfuryl fluoride scrubbing method.

### CROSS-REFERENCE TO RELATED APPLICATIONS

This application claims the benefit of U.S. Provisional Application No. 63/273,394, filed on Oct. 29, 2021, which is incorporated into this application by reference in its entirety.

### STATEMENT REGARDING FEDERALLY SPONSORED RESEARCH

This invention was funded by a grant (PN 21-02) from the U.S. Department of Agriculture FAS/TASK (Technical Assistance for Specialty Crops) Program managed by the California Prune Board (CPB). The government has certain rights in the invention.

### BACKGROUND

Sulfuryl fluoride (SO₂F₂) has a long history as a fumigant for the extermination of insects in both residential and agricultural applications. Developed in 1957, sulfuryl fluoride has increased in importance in postharvest applications, as it has replaced the fumigant methyl bromide, which is an ozone depleting chemical. Postharvest fumigation with sulfuryl fluoride is used to control stored product insect pests in many foods and other commodities; for example, dried fruit and tree nut exports to the European Union (“EU”), valued at 4 billion USD annually. Sulfuryl fluoride is also used as a fumigant to exterminate insect pests in dwellings and other properties.

Nevertheless, sulfuryl fluoride is a potent greenhouse gas. It has an atmospheric lifetime of 30-40 years and is 4000-5000 times more efficient (per kg) in trapping infrared radiation than carbon dioxide. Further, sulfuryl fluoride is hazardous to humans. Inhalation may result in respiratory irritation, pulmonary edema, nausea, abdominal pain, central nervous system depression, numbness in the extremities, muscle twitching, seizures, and death.

Data related to limiting, or eliminating, atmospheric emissions of sulfuryl fluoride is required by the EU, under Implementing Regulation 2017/270, to support its continued use. Currently, there are no viable alternatives to sulfuryl fluoride that would support a continued export of commodities to the EU, as methyl bromide is banned, and phosphine-another alternative fumigant-requires treatment durations that are too long to satisfy logistical constraints. Individual growers and shippers, fumigation service providers, and Douglas Products (the registrant of sulfuryl fluoride) are not positioned, technically or financially, to address regulatory demands of the EU or other foreign trade partners.

During fumigation, the container enclosing the commodity is filled with the gas for a time, depending on the commodity and other factors, and the container is then vented. Venting to the atmosphere has been the norm, but several strategies for removing sulfuryl fluoride in exhaust streams have been investigated. Packed-bed dielectric barrier discharge, which operates by direct collision of energetic electrons, is effective; but it requires a second chemical absorption step to remove byproducts (sulfur dioxide, ozone, and nitric oxide) and is costly to operate. Physical capture of sulfuryl fluoride using biobased solvents or alkoxy alkyl acetate esters requires high volumes of solvent and additional steps associated with recycling the captured sulfuryl fluoride.

Alkaline hydrolysis (potassium hydroxide, pH˜13) has been investigated as a method for removing sulfuryl fluoride. Treatment is carried out by passing forced vent streams through a spray scrubber in which the vent gases intermingle with a spray of the desired treatment solution. The reaction of sulfuryl fluoride with hydroxide occurs as follows:

SO₂F₂+OH⁻→FSO₃⁻+F⁻+H⁺

Unfortunately, sulfuryl fluoride is not very soluble in water, and the rate constant for the reaction is apparently not sufficiently large, so the rate of the reaction is inconveniently slow, which requires either limiting the flow rate of the vent gasses passing through the scrubber or recycling the vent gases through the scrubber multiple times to achieve the desired level of destruction. Moreover, the products of this reaction must be disposed of properly because fluoride at high concentrations is hazardous to humans and the environment. Some evidence suggests that fluorosulfate may pose a hazard to humans due to the similarity in its behavior to certain toxic anions, but the toxicity of fluorosulfate has not been fully investigated. As fluorosulfate is highly persistent in aqueous media, it would be prudent to preclude its formation.

### SUMMARY

This application relates to a method of removing sulfuryl fluoride from a fluid with a scrubbing medium comprising (a) an aqueous solution of a base and (b) a peroxide having at least one —O—OH group. This method is performed under conditions sufficient to react at least a portion of the sulfuryl fluoride with the peroxide to form a sulfuryl fluoride byproduct.

Also described in this application is a kit for removing sulfuryl fluoride from a fluid in a scrubbing medium by forming a sulfuryl fluoride byproduct. The kit can comprise (a) a peroxide having at least one —O—OH group, or a precursor capable of generating the peroxide in the scrubbing medium; and (b) a base in an amount effective to dissociate the proton from the at least one —O—OH group in the scrubbing medium. Optionally, the kit can comprise one or more indicators capable of detecting amounts of the peroxide, the base, or the sulfuryl fluoride byproduct in the scrubbing medium.

### BRIEF DESCRIPTION OF THE DRAWINGS

The foregoing summary, as well as the following description of the disclosure, is better understood when read in conjunction with the appended drawings. For the purpose of illustrating the disclosure, the drawings illustrate some, but not all, alternative embodiments. This disclosure is not limited to the precise arrangements and instrumentalities shown. The following figures, which are incorporated into and constitute part of the specification, assist in explaining the principles of the disclosure.

FIG. 1 shows a flow-through reactor suitable for evaluating and testing the described scrubbing method.

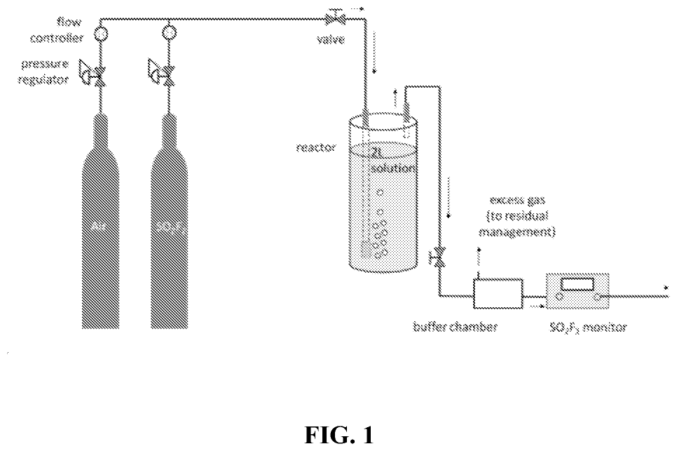

FIG. 2A shows representative data illustrating fluoride ion appearance and initial and final pH after the injection of sulfuryl fluoride gas into a sealed container of alkaline solution with different concentrations of hydrogen peroxide (HP).

FIG. 2B shows representative data illustrating fluoride ion appearance after the injection of sulfuryl fluoride gas into a sealed container of alkaline solution with different concentrations of hydrogen peroxide (HP).

FIG. 3 is a line graph illustrating the effect of phosphate (PP) on the rate of fluoride ion appearance when added in conjunction with hydrogen peroxide.

FIG. 4 is a line graph illustrating the effect of pyrophosphate on the rate of fluoride ion appearance when added in conjunction with hydrogen peroxide.

FIG. 5 shows representative data illustrating fluoride ion appearance after the injection of sulfuryl fluoride gas into alkaline solutions with hydrogen peroxide, peroxyacetic acid, and a phosphate buffer.

FIG. 6 is a line graph illustrating the effect of carbonate on the rate of fluoride ion appearance when added in conjunction with hydrogen peroxide.

FIG. 7 shows representative data illustrating fluoride ion appearance after the injection of sulfuryl fluoride gas into alkaline peroxymonosulfate solutions.

FIG. 8 is a line graph illustrating fluoride ion appearance after the injection of sulfuryl fluoride gas into sodium peroxycarbonate solutions.

FIG. 9 is a line graph illustrating fluoride ion appearance after the injection of sulfuryl fluoride gas into sodium perborate solutions.

FIG. 10 shows representative data illustrating fluoride ion concentration remaining in the aqueous phase 30 minutes after the addition of calcium hydroxide to an alkaline solution containing sodium fluoride.

### DETAILED DESCRIPTION

The current state of sulfuryl fluoride scrubbing technology relies on aqueous solutions of sodium hydroxide or potassium hydroxide, which react with the dissolved sulfuryl fluoride by base hydrolysis. This reaction results in one mole of fluorosulfate and one mole of fluoride ion per mole of sulfuryl fluoride. A serious drawback is that this method is inconveniently slow because effective removal of sulfuryl fluoride requires limiting the flow rate or recycling the gases through the scrubber multiple times. This may be due to gas-to-liquid mass transfer limitations because of the low aqueous solubility of sulfuryl fluoride, or to inherently limited reaction rates of sulfuryl fluoride with hydroxide, or a combination of both. Another drawback of alkaline hydrolysis is the formation of fluorosulfate, which is stable to further hydrolysis. The toxicity and environmental hazards of fluorosulfate have not been investigated, but fluorosulfate should be considered persistent and potentially hazardous if released into the environment.

The improved scrubbing method described in this application involves addition of a peroxide with at least one —O—OH group to an alkaline solution. Without being bound by theory, the inventors believe the sulfuryl reaction occurs as follows:

OH⁻+ROOH⇄H₂O+ROO⁻

F-SO₂-F+ROO⁻→sulfur product+2F⁻

R can be an atom or group of atoms attached to the peroxide. It is thought that the peroxide is first dissociated (e.g., pKₐ=11.6 for hydrogen peroxide) and the resulting anion reacts by nucleophilic attack on sulfuryl fluoride to liberate two moles of fluoride. This reaction pathway has a two-fold effect relative to base hydrolysis:(a) it significantly accelerates the rate of fluoride ion release and (b) it roughly doubles the amount of fluoride ion released.

### A. Sulfuryl Fluoride Scrubbing Method

The scrubbing method comprises contacting a fluid contaminated with sulfuryl fluid with a scrubbing medium that comprises (a) an aqueous solution of a base, and (b) a peroxide having at least one —O—OH group; under conditions sufficient to react at least a portion of the sulfuryl fluoride with the peroxide to form a sulfuryl fluoride byproduct. For many post-fumigation scrubbing methods, the fluid will comprise air. “Scrubbing medium” refers to any medium through which a fluid comprising sulfuryl fluoride (e.g., a fumigant) is passed or placed into contact with.

The aqueous solution of the base should have a pH of 7 or higher. One aspect of the method that is counterintuitive is that there have been reports of sulfuryl fluoride purification using hydrogen peroxide. But these methods do not involve the use of a base. These methods are not aimed at degrading sulfuryl fluoride. See e.g., JP2000063107. A basic aqueous solution in the scrubbing medium (pH of 7 or higher, or 7.1 or higher) ensures adequate reaction of the sulfuryl fluoride with the peroxide. In some embodiments, the pH of the aqueous solution of the base ranges from 7 to 13, e.g., 7.5 to 13, 8 to 13, 8.5 to 13, 9 to 13, 9.5 to 13, 10 to 13, 10.5 to 13, or 11 to 13. In further embodiments, the pH of the aqueous medium ranges from 10 to 12, e.g., 11 to 12.

Suitable bases include water-soluble hydroxides of an alkali or alkaline earth metal, a carbonate, a bicarbonate, a phosphate, a pyrophosphate, or a borate. In some embodiments, the base is sodium hydroxide, potassium hydroxide, sodium carbonate, potassium carbonate, sodium borate, or potassium borate. Any combination of two or more of any disclosed base can also be used. The term “base” refers to a general base, i.e., a base that directly removes a proton from the peroxide having at least one —O—OH group, or a specific base, which can buffer the concentration of hydroxide ion in solution and permit enough hydroxide ion to remove a proton from the peroxide. Thus, in some embodiments, the term “base” can be synonymous with the term “buffer.”

A variety of peroxides and peroxide precursors can be used, provided they have or form a compound having at least one —O—OH group. As described above, it is believed that the hydrogen atom of the peroxide is removed in the aqueous solution to form a peroxy anion, which then reacts with sulfuryl fluoride to provide the byproduct of sulfuryl fluoride. Suitable peroxides include hydrogen peroxide, peroxyacetic acid, a peroxymonosulfate, or sodium peroxycarbonate. In some embodiments, hydrogen peroxide is preferred due to its wide commercial availability and relatively low cost.

When hydrogen peroxide is used, the pH can be adjusted to a high enough value such that a significant percentage of hydrogen peroxide molecules are converted to the hydroperoxide anion form (50% at pH=pKₐ=11.6). Additional base can be useful to neutralize the hydrogen ions that are produced in the reaction. The sulfuryl fluoride fluid can be passed through a reactor containing the alkaline solution to achieve effective mass transfer of sulfuryl fluoride from the gas phase to the liquid phase. This may be accomplished in a spray scrubber, or similar apparatus capable of sufficient agitation or mixing.

A monitor sensitive to sulfuryl fluoride concentration can be placed in the vent stream emitted from a suitable scrubber or reactor to adjust the flow rate to a value that results in the desired level of sulfuryl fluoride destruction. After treatment, a computed amount of calcium hydroxide or soluble calcium salt is introduced into the reactor and mixed with the reactor contents for a sufficient length of time to achieve a desired level of fluoride ion removal from the aqueous phase.

The stoichiometry of the reaction between a hydroperoxide and sulfuryl fluoride can be determined by monitoring the formation of fluoride and the consumption of the peroxide in the reaction mixture with stepwise injection of sulfuryl fluoride. It was determined that for every mole of sulfuryl fluoride injected, 1.85 moles of fluoride ion were produced and 1.76 moles of hydrogen peroxide were consumed. Given a minor contribution from OH⁻ hydrolysis, the reaction is believed to proceed as follows (although the scope of this application is not limited by any theory):

SO₂F₂+2HO₂⁻+→sulfur product+2F⁻

It was found that radicals such as sulfate (SO₄⁻·) and hydroxyl (OH·) were not involved in the SO₂F₂-HO₂⁻ reaction, as adding 200 mM of methanol, which can scavenge both radicals, did not affect the release of fluoride from sulfuryl fluoride. Therefore, the reaction between sulfuryl fluoride and hydrogen peroxide is believed to be a two-electron (nucleophilic/electrophilic) reaction, as shown in the above equation.

In place of or in addition to peroxides having at least one —O—OH group in the scrubbing medium, peroxide precursors can also be used, i.e., a peroxide precursor can be added to the scrubbing medium and then form or release a peroxide having at least one —O—OH group in the medium (e.g., in situ or electrochemically). Precursors include those that may be considered a “peroxide” as the term is used in the art but that do not have at least one —O—OH group. Examples include metal peroxides, e.g., MO₂, where M is a metal such as magnesium or calcium. Other suitable precursors include metal peroxycarbonates such as sodium peroxycarbonate, in addition to adducts capable of liberating hydrogen peroxide in the scrubbing medium. Thus, specific non-limiting examples of suitable precursors include sodium perborate, calcium peroxide, magnesium peroxide, or urea peroxide. Any combination of two or more peroxides having at least one —O—OH group or precursors can also be used.

The peroxide or precursor can be combined with the aqueous basic solution in a number of ways. In some embodiments, the peroxide or precursor is water soluble and can be combined as a solute directly with the aqueous medium of the base. In other embodiments, the peroxide or precursor can be insoluble or partially insoluble and combined with the aqueous medium as a solid or semi-solid. In one example, the peroxide or precursor can be added as fine particles suspended in the aqueous medium. In another example, the peroxide or precursor can be contained in a cartridge that is combined with the aqueous medium.

In some embodiments, the scrubbing medium can further comprise a pH buffer, for example in the aqueous solution. The pH buffer can be useful for maintaining the pH of the aqueous solution as sulfuryl fluoride contacts the medium in the presence of a general base catalyst. In some embodiments, the pH buffer is a phosphate, a pyrophosphate, a carbonate, or a borate.

It is understood that a substance such as a phosphate, carbonate, pyrophosphate, borate, and the like, can act as a general base catalyst or a specific base catalyst. A general base catalyst refers to a base (e.g., a phosphate) that can itself remove the hydrogen from the peroxide having the at least one —O—OH group. A specific base catalyst, by contrast, refers to a buffer which through acid-base equilibrium with water, controls the concentration of general base ion (e.g., hydroxide ion) which is the species that removes the hydrogen from the peroxide.

In some embodiments, water-miscible organic solvents, such as ethylene glycol, can be added to the aqueous medium. Thus, in one embodiment, the scrubbing medium or the aqueous solution can include water-miscible organic solvents such as ethylene glycol. In another embodiment, the scrubbing medium or the aqueous solution is free of water-miscible organic solvents such as ethylene glycol.

“Sulfuryl fluoride byproduct” refers to any product resulting from the reaction of sulfuryl fluoride with the peroxide (or peroxide precursor) in the scrubbing medium. In some embodiments, the sulfuryl fluoride byproduct comprises a sulfur-containing product and fluoride. In these embodiments, fluoride can itself be an environmental concern, and thus the scrubbing method can further comprise the step of precipitating the fluoride from the scrubbing medium. One way of precipitating the fluoride from the scrubbing medium is to contact the scrubbing medium with a suitable metal salt such as calcium chloride, calcium hydroxide, or any water-soluble calcium salt, to form a precipitated metal fluoride.

In one specific embodiment, the method comprises contacting a fluid such as air that contains sulfuryl fluoride with a scrubbing medium that comprises (a) an aqueous solution of a base (e.g., sodium hydroxide, potassium hydroxide, or a carbonate, together with optional phosphate or pyrophosphate buffer), and (b) a peroxide having at least one —O—OH group (e.g., H₂O₂ or peroxyacetic acid); under conditions (e.g., pH 10-13) sufficient to react at least a portion of the sulfuryl fluoride with the peroxide to form a byproduct of sulfuryl fluoride and fluoride ion. In one example of this embodiment, the fluoride ion can then be precipitated from the scrubbing medium with a suitable calcium salt.

In another specific embodiment, the method comprises contacting a fluid such as air that contains sulfuryl fluoride with a scrubbing medium that comprises at least one of peroxymonosulfate (with optional carbonate), peroxycarbonate, or perborate; under conditions (e.g., pH 10-13) sufficient to form a byproduct of sulfuryl fluoride and fluoride ion. In one example of this embodiment, the fluoride ion can then be precipitated from the scrubbing medium with a suitable calcium salt.

### B. Kit Suitable for Use with Scrubbing Method

In addition to the scrubbing method, this application relates to a kit for removing sulfuryl fluoride from a fluid in a scrubbing medium by forming a byproduct of sulfuryl fluoride. In one embodiment, the kit comprises: a peroxide having at least one —O—OH group, or a precursor capable of generating the peroxide in the scrubbing medium; a base in an amount effective to dissociate the proton from at least one —O—OH group in the scrubbing medium; and optionally, one or more indicators capable of detecting amounts of the peroxide, the base, or the byproduct of sulfuryl fluoride in the scrubbing medium. The optional indicators, which are known in the art, can be useful to monitor the progress of the scrubbing reaction.

The term “kit” refers to a collection of at least two components that constitute a unit for a given purpose. Individual member components of the kit may be physically packaged together or separately.

In some embodiments of the kit, the base is a water-soluble hydroxide of an alkali or alkaline earth metal, a carbonate, a bicarbonate, a phosphate, a pyrophosphate, or a borate. In further embodiments of the kit, the base is sodium hydroxide, potassium hydroxide, sodium carbonate, potassium carbonate, sodium borate, or potassium borate.

In some embodiments of the kit, the peroxide can be hydrogen peroxide, peroxyacetic acid, a peroxymonosulfate, or a peroxycarbonate. In one embodiment of the kit, the peroxide is hydrogen peroxide. Peroxide precursors can be a metal peroxide, a metal peroxycarbonate, or an adduct capable of liberating hydrogen peroxide in the scrubbing medium. Specific examples of precursors include sodium perborate, calcium peroxide, magnesium peroxide, or urea peroxide.

Embodiments of the kit can also comprise a pH buffer. In some embodiments, the pH buffer is a phosphate, a pyrophosphate, a carbonate, or a borate.

In a further embodiment, the kit can comprise a component that enables a user to remove the fluoride from the scrubbing medium. In one embodiment, the kit can comprise a metal salt capable of precipitating fluoride from the scrubbing medium.

### C. Examples

The following examples further illustrate this disclosure. The scope of the disclosure and claims is not limited by the scope of the examples.

### 1. Testing Nucleophiles for Displacement of Fluoride from Fluorosulfate

Previous research reported that hydrolysis of fluorosulfate under either strongly alkaline or strongly acidic conditions is extremely slow (Jones and Lockhart, 1968). In order to find a suitable reagent to displace fluoride from fluorosulfate, we screened several compounds whose anionic form is more nucleophilic than hydroxide (10.5 in H₂O), including sulfite (16.8 in H₂O), thiocyanate (17.9 in CH₃CN), azide (20.5 in dimethylsulfoxide), dimethyldithiocarbamate (20.9 in CH₃CN), L-cysteine (23.4 in H₂O), thioacetate (21.2 in CH₃CN), thioglycolate (22.6 in H₂O), and hydroperoxide (15.4 in H₂—)—the number in parentheses is the Mayr nucleophilicity parameter for the anion in log units (Duan et al., 2011; Mayr and Ofial, 2015; Minegishi and Mayr, 2003; Phan and Mayr, 2006). The pH was adjusted to ensure the predominance of the anionic form.

Among the selected nucleophiles, only hydroperoxide (a peroxide having at least one —O—OH group) successfully released fluoride quantitatively. However, the reaction of fluorosulfate with hydroperoxide was relatively slow, requiring more than 2 days at 21° C. or several hours at 50° C. The other nucleophiles were no more effective than the control (water at pH 12).

### 2. Alkaline Hydrogen Peroxide Solutions for Absorbing Sulfuryl Fluoride

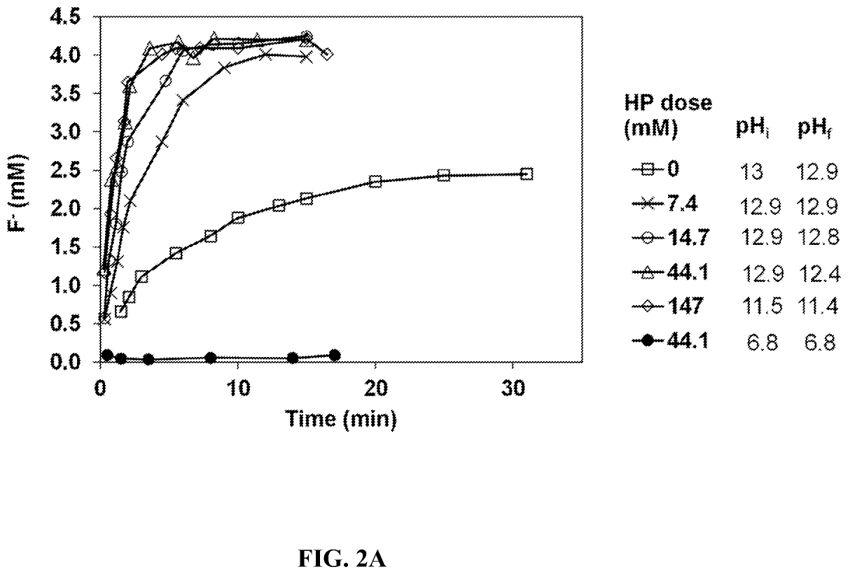

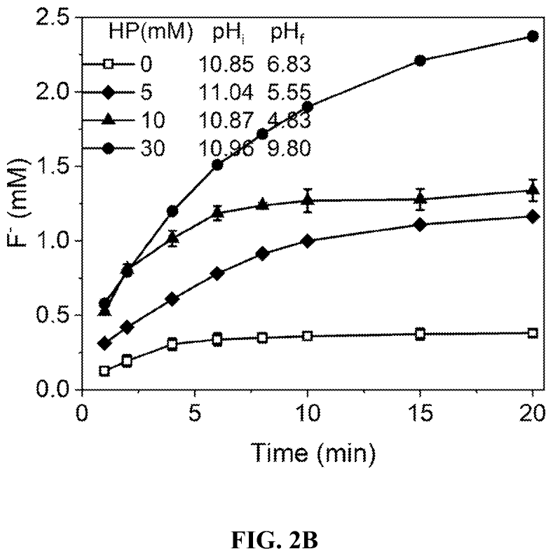

To measure fluoride ion appearance, a known volume (4 or 5 mL) of pure sulfuryl fluoride gas (at atmospheric pressure and room temperature) was injected into sealed batch reactors containing a known volume (70 mL or 100 mL) of alkaline solution with different concentrations of hydrogen peroxide and approximately 10-40 mL headspace. This resulted in various pH values in the aqueous mixtures. Theoretically, in FIG. 2A release of one and two moles of fluoride per mole of sulfuryl fluoride corresponds to the appearance of 2.9 mM and 5.8 mM fluoride, respectively, in the solution. In FIG. 2B release of one and two moles of fluoride per mole of sulfuryl fluoride corresponds to the appearance of 1.6 mM and 3.2 mM fluoride, respectively, in the solution.

As shown in FIG. 2A-B, in a sodium hydroxide solution at pH 13 (without any hydrogen peroxide), fluoride was released over a 30-minute period and leveled off at about 48 mg/L, which approaches half the theoretical value of 110 mg/L if all the F in sulfuryl fluoride were converted to fluoride ions. No significant fluoride was released when the reactor liquid was ordinary tap water (pH 6.8) (FIG. 2A).

In contrast, adding hydrogen peroxide had a two-fold effect relative to the hydroxide solution alone: 1) it greatly accelerated fluoride release, shortening the time needed for release to level off to less than 5 min at high H₂O₂ concentrations (44.1-147 mM) from more than 30 min without H₂O₂; and 2) it almost doubled the amount of the fluoride ion released (2.4 mM without H₂O₂ vs. 4.2 mM with H₂O₂ in FIG. 2A; and 0.6 mM without H₂O₂ vs. 2.4 mM with H₂O₂ in FIG. 2B). This suggests that alkaline hydrogen peroxide solutions are more effective at breaking the S-F bonds in sulfuryl fluoride compared to alkali alone.

As FIG. 2A-B demonstrates, increasing the applied H₂O₂ concentration enhanced fluoride formation rates until a plateau was reached at 44.1 mM. Theoretically, an increase of the H₂O₂ concentration would favor the hydroperoxide pathway over the hydroxide pathway, resulting in an increase in the fluoride yield. This occurred when the H₂O₂ increased from 7.4 to 14.7 mM, but a further increase of H₂O₂ did not lead to a noticeable additional increase of the final fluoride concentrations, which indicates diminishing benefits with incremental H₂O₂ dose increase above certain levels.

Rate acceleration in the presence of H₂O₂ at high pH can be explained by the high nucleophilicity towards sulfuryl fluoride of the hydroperoxide compared to hydroxide. According to the Mayr nucleophilicity/electrophilicity reactivity equation, hydroperoxide is 117 times more nucleophilic than hydroxide in water. The near doubling of fluoride concentration by adding H₂O₂ indicates that both fluorine atoms of sulfuryl fluoride are released rapidly. In comparison, hydroxide can only remove one fluorine from sulfuryl fluoride, leaving the other one in the byproduct, fluorosulfate.

Fluoride release with H₂O₂ was not exactly twice that without H₂O₂ because the hydroperoxide reaction was in competition with hydroxide hydrolysis, so a small amount of fluorosulfate was generated even in the presence of H₂O₂. The rapid release of the second fluoride of sulfuryl fluoride in the presence hydrogen peroxide contrasts with the slow release of fluoride during reaction of alkaline hydrogen peroxide with fluorosulfate. Thus, the reaction of hydroperoxide with sulfuryl fluoride and fluorosulfate takes place by different pathways.

The results support the strategy of using H₂O₂ in alkaline solution for sulfuryl fluoride control as it can effectively eliminate both the parent compound and the persistent fluorosulfate byproduct.

### 3. Addition of Phosphate to Hydrogen Peroxide

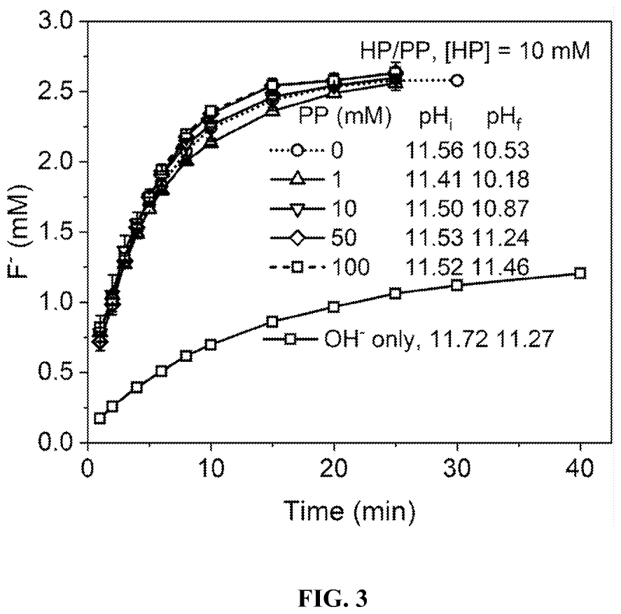

Phosphate buffer was added to the alkaline hydrogen peroxide solution to assess effect on fluoride ion appearance. As shown in FIG. 3, results indicated that phosphate had little or no effect on the rate of fluoride ion appearance when phosphate was added at concentrations up to 100 mM.

Nevertheless, the pH buffering effect of phosphate was beneficial. Without phosphate, the pH dropped from 11.56 to 10.53, but with phosphate at 100 mM, the pH declined only slightly from 11.52 to 11.46.

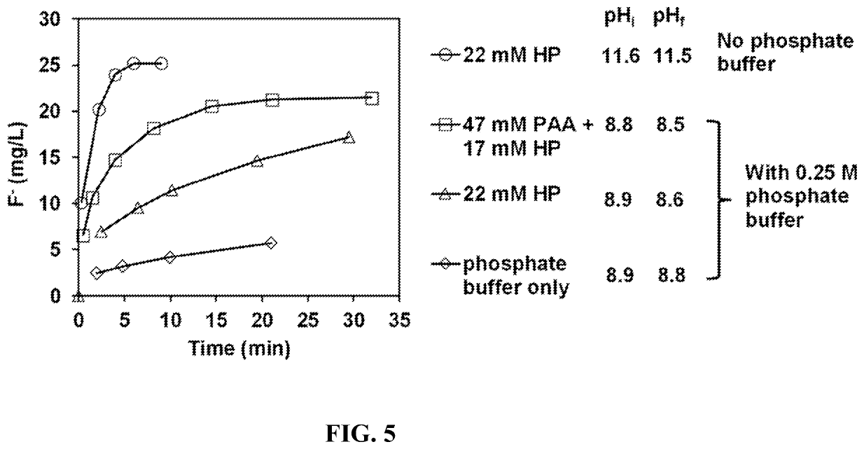

It should be noted that in FIGS. 3, 4, 6, 7, 8, and 9, release of one and two moles of fluoride per mole of sulfuryl fluoride corresponds to the appearance of 1.6 mM and 3.2 mM fluoride, respectively, in the solution. In FIGS. 2A and 5, release of one and two moles of fluoride per mole of sulfuryl fluoride corresponds to the appearance of 2.9 mM and 5.8 mM fluoride, respectively, in the solution. This is due to the amount of sulfuryl fluoride added per mL of solution. In some examples, the reaction was cut short because the ultimate quantity of fluoride ion released was not the objective of the trial.

### 4. Addition of Pyrophosphate to Hydrogen Peroxide

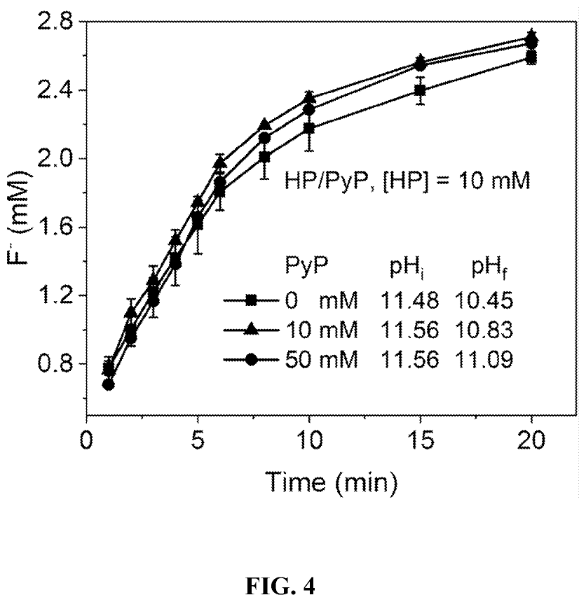

As shown in FIG. 4, adding pyrophosphate (P₂O₇⁴⁻, “PyP”) to an alkaline hydrogen peroxide solution had a similar benefit as phosphate. Adding PyP to the scrubbing solution slightly increased the rate of fluoride ion appearance when PyP was added at concentrations up to 50 mM.

Like phosphate, the buffering effect of PyP was beneficial. Without PyP, the pH dropped from 11.48 to 10.45, whereas with PyP at 50 mM, the pH declined only from 11.48 to 11.09.

### 5. Addition of Peroxyacetic Acid and Phosphate Buffer to Hydrogen Peroxide

As shown in FIG. 5, peroxyacetic acid (“PAA”) with H₂O₂ and phosphate lowers pH without significantly decreasing fluoride ion appearance after 30 minutes. FIG. 5 shows that at alkaline pH of about 8.8-8.9 the combination of peroxyacetic acid and hydrogen peroxide releases fluoride more rapidly than hydrogen peroxide alone.

### 6. Addition of Carbonate to Hydrogen Peroxide

Because the pH drops during the reaction between hydrogen peroxide and sulfuryl fluoride (due to hydroxide consumption), the scrubbing liquid can be monitored and KOH or NaOH metered in to maintain a sufficiently high pH. We considered using alternative sources of alkali, like carbonate (“CB,” Na or K salt), that could buffer the hydroxide ion concentration. Carbonate has a pKₐ of 10.3, so we hypothesized that carbonate would act as a buffer by providing a steady state concentration of hydroxide:

CO₃²⁻+H₂O [symbol] OH⁻+HCO₃⁻

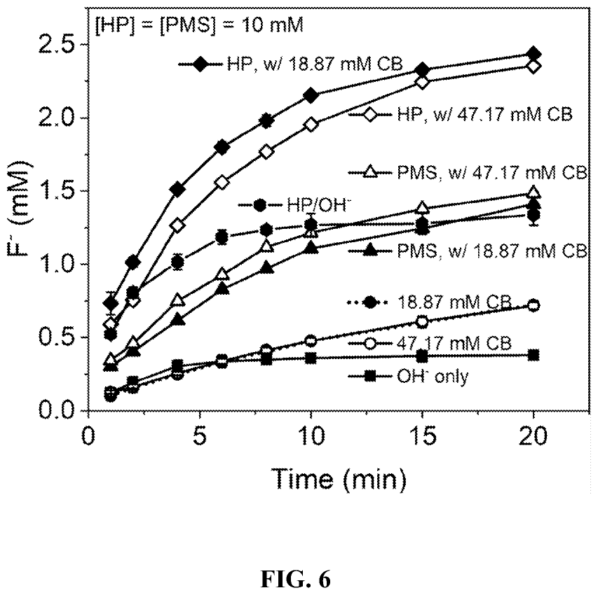

As shown in Table 1, carbonate buffered the pH during the reactions reported in FIG. 6.

TABLE 1
Effect of Carbonate on pH

| OH⁻ | NaCO₃ | H₂O₂ | PMS | Initial | Final |
|---|---|---|---|---|---|
| (mM) | (mM) | (mM) | (mM) | pH | pH |
| 0 | 18.87 (2 g/L) | 10 | 0 | 10.93 | 10.41 |
| 0 | 47.17 (5 g/L) | 10 | 0 | 11.06 | 10.74 |
| 0 | 47.17 | 0 | 10 | 10.43 | 10.31 |
| 0 | 18.87 | 0 | 10 | 9.97 | 9.64 |
| 0.74 | 0 | 10 | 0 | 10.87 | 4.83 |
| 0 | 18.87 | 0 | 0 | 11.12 | 10.89 |
| 0 | 47.17 | 0 | 0 | 11.27 | 11.07 |
| 0.71 | 0 | 0 | 0 | 10.85 | 7.00 |

As illustrated by FIG. 6, carbonate mitigated the decline of fluoride ion appearance compared to KOH because it kept the pH from dropping to disadvantageous values, such as 7 or below.

### 7. Peroxymonosulfate for Absorbing Sulfuryl Fluoride

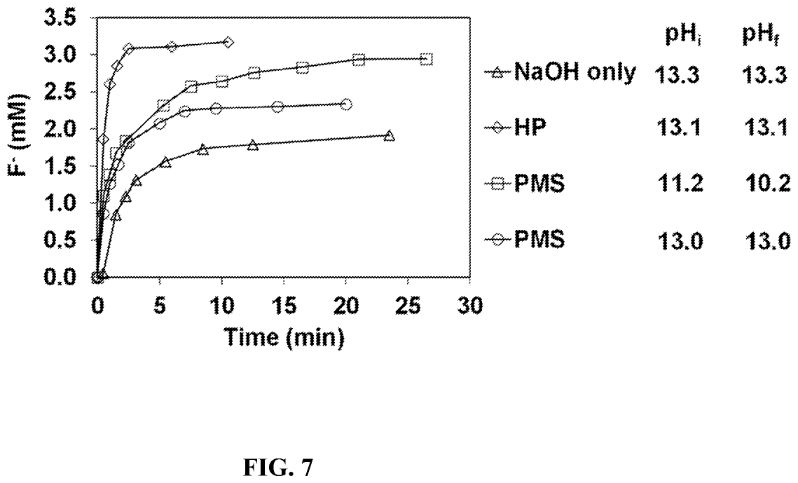

Given the high reactivity of the hydroperoxide anion, another peroxide compound, peroxymonosulfate (HSO₅⁻), was tested for transforming sulfuryl fluoride. Peroxymonosulfate (“PMS”) has a pKₐ of 9.3 (Evans and Upton, 1985), and the corresponding dianion (SO₅²⁻) is reported to be a strong nucleophile (N=14.41), about 178-times more reactive than hydroxide in water (Mayer and Ofial, 2018). FIG. 7 shows that PMS at an initial pH of 11.2 reacted with sulfuryl fluoride to produce fluoride ions in a SO₂F₂-fluoride ion stoichiometry close to 1:2, which is the same as hydrogen peroxide. Increasing the pH to 13 decreased the fluoride yield likely because of the greater contribution from hydroxide hydrolysis and the decomposition of PMS at the higher pH.

Overall, PMS removed sulfuryl fluoride more slowly than hydrogen peroxide in an alkaline solution. However, as it has a lower pKₐ than hydrogen peroxide, PMS may function at a lower pH range, saving on alkali and reducing the generation of fluorosulfate.

### 8. Addition of Carbonate to Peroxymonosulfate

As shown in FIG. 6, peroxymonosulfate combined with carbonate effectively converted sulfuryl fluoride to fluoride, but it was slower than hydrogen peroxide combined with carbonate.

### 9. Comparison of Hydrogen Peroxide to Sodium Peroxycarbonate

Sodium peroxycarbonate (“SPC”) is a solid that is a “perhydrate” of sodium carbonate (i.e., a weakly bonded adduct of hydrogen peroxide and sodium carbonate salt). Thus, when dissolved it generates a solution containing sodium cations, carbonate anions, and hydrogen peroxide molecules in equilibrium with hydroperoxide anions.

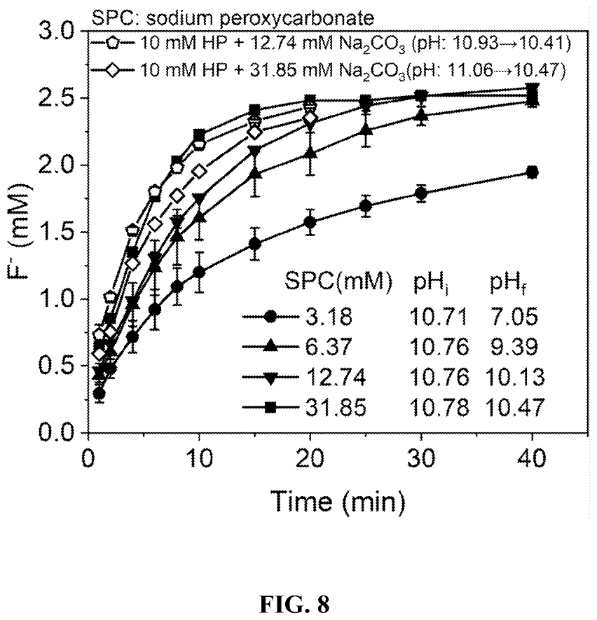

As demonstrated in FIG. 8, SPC behaved equally well or slightly better than the mixture of sodium carbonate and hydrogen peroxide and buffered the pH as long as the SPC concentration exceeded about 5 g/L. Its advantage over separate chemicals is that it requires only a single reagent-instead of two. Its disadvantage is that it would likely be more expensive than the combination.

### 10. Comparison of Hydrogen Peroxide to Sodium Perborate

Sodium perborate (“SPB”) is a peroxy compound in the solid state, but when dissolved in water it hydrolyzes to give a moderately alkaline (pH˜10) solution containing hydrogen peroxide,B (OH)₃, andB (OH) 4 in equilibrium with a small concentration of monoperoxyborate, HOO—B(OH)₃⁻.

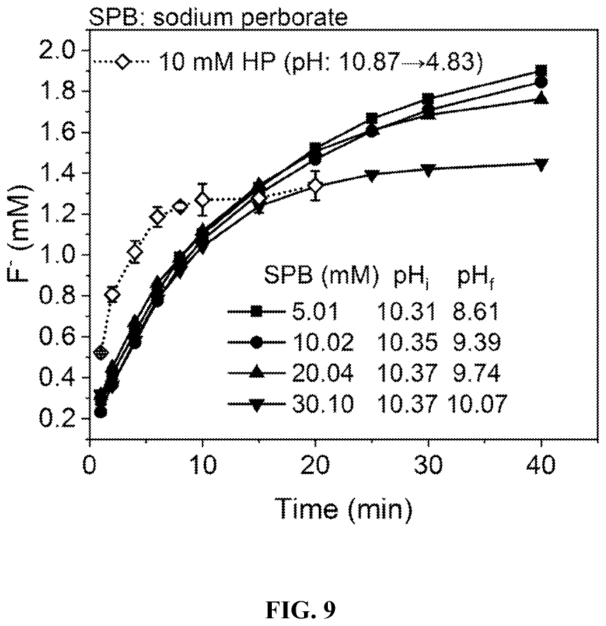

As shown in FIG. 9, SPB was effective in converting sulfuryl fluoride to fluoride ions. The SPB buffers the pH due to the borate salts resulting from SPB hydrolysis. The buffering effect mitigates the downward drift in pH exhibited by the unbuffered peroxide solution with KOH. Solutions of SPB were initially somewhat slower than the unbuffered solution with KOH, but this was likely due to the higher initial pH of the unbuffered peroxide solution (10.87 compared to 10.31-10.36). At the high SPB concentration (30.10 mM), the reaction seems to have been inhibited by the buffer ions.

### 11. Precipitation of Fluoride with Calcium Hydroxide

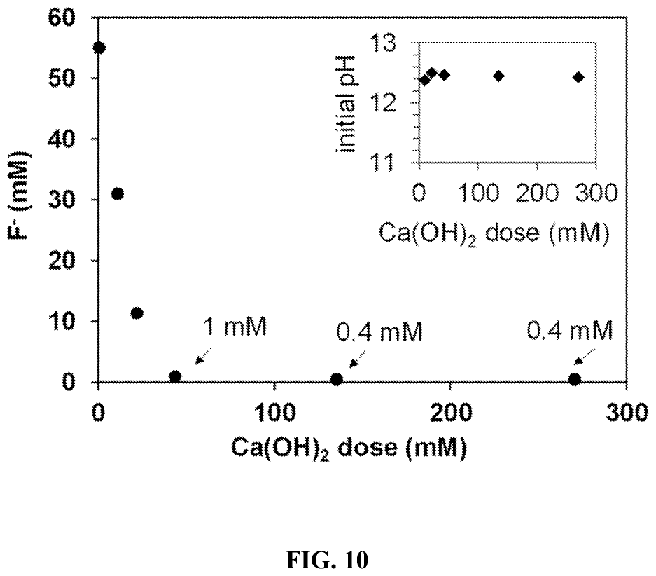

Fluoride at high concentrations is hazardous to humans and the environment (Barbier et al., 2010), so a method to remove fluoride from the spent scrubbing liquid is necessary. As shown in FIG. 10, the addition of calcium hydroxide, Ca(OH) 2, to an alkaline solution containing sodium fluoride at 55.3 mM at room temperature greatly reduced the fluoride ion concentration in the liquid phase. The addition of calcium hydroxide at as little as 3 g/L (40.5 mM) reduced fluoride ion concentration to <1 mM, corresponding to >98.2% removal from the liquid phase. Higher doses reduced fluoride even further (to 99.3%). Thus, calcium hydroxide added after scrubbing sulfuryl fluoride effectively removed a potentially harmful product, fluoride ion, from the spent scrubbing liquid.

Calcium fluoride (CaF₂) is known to be highly insoluble, so the mechanism of removal is likely precipitation of calcium fluoride. It was observed in a separate experiment that addition of a water-soluble calcium salt, calcium chloride (CaCl₂)), to a solution of sodium fluoride at 55.3 mM in deionized water resulted in formation of a precipitate, presumably calcium fluoride. Thus, one may add a water-soluble calcium salt instead of calcium hydroxide to precipitate fluoride in the scrubbing mixture. Importantly, sufficient calcium salt presumably would have to be added to overcome precipitation of calcium hydroxide by reaction of calcium ions with hydroxide ions.

Also, the calcium hydroxide or soluble calcium salt should preferably be added after the sulfuryl fluoride scrubbing process is complete; adding calcium during scrubbing interferes with performance by forming insoluble calcium peroxide (CaO₂), which is less reactive towards sulfuryl fluoride than freely dissolved hydrogen peroxide. As an added benefit, the resulting calcium fluoride is potentially recoverable for purification and resale.

### 12. Comparative Example: Peroxydisulfate

Both oxygen atoms in peroxydisulfate's peroxide group are attached to sulfate groups. It was found that peroxydisulfate was completely unreactive.

### 13. Metal Peroxides

Preliminary data on calcium peroxide and magnesium peroxide indicated that they liberate fluoride from sulfuryl fluoride, but the rates are not known. Both are solids and probably would have to be deployed in cartridge mode—i.e., passing the vent gases through a cartridge containing particles or pellets of the reagent.

### 14. References

Barbier, O., Arreola-Mendoza, L. and Del Razo, L. M. 2010. Molecular mechanisms of fluoride toxicity. Chemico-Biological Interactions 188 (2), 319-333.

Duan, X.-H., Maji, B. and Mayr, H. 2011. Characterization of the nucleophilic reactivities of thiocarboxylate, dithiocarbonate and dithiocarbamate anions. Organic & Biomolecular Chemistry 9 (23), 8046-8050.

Evans, D. F. and Upton, M. W. 1985. Studies on singlet oxygen in aqueous solution. Part 3. The decomposition of peroxy-acids. Journal of the Chemical Society, Dalton Transactions (6), 1151-1153.

Jones, M. M. and Lockhart, W. L. 1968. Kinetics of decomposition of the fluorosulphate ion in aqueous solution. Journal of Inorganic and Nuclear Chemistry 30 (5), 1237-1243.
Mayer, R. J. and Ofial, A. R. 2018. Nucleophilic Reactivities of Bleach Reagents. Organic Letters 20 (10), 2816-2820.
Mayr, H. and Ofial, A. R. 2015. A quantitative approach to polar organic reactivity. SAR and QSAR in Environmental Research 26 (7-9), 619-646.
Minegishi, S. and Mayr, H. 2003. How Constant Are Ritchie's “Constant Selectivity Relationships”? A General Reactivity Scale for n-, π-, and σ-Nucleophiles. Journal of the American Chemical Society 125 (1), 286-295.
Phan, T. B. and Mayr, H. 2006. Nucleophilic reactivity of the azide ion in various solvents. Journal of Physical Organic Chemistry 19 (11), 706-713.

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other methods and systems for carrying out the several purposes of this disclosure. As a result, the claims should not be considered as limited by the description or examples.

1. A method for removing sulfuryl fluoride from a fluid, the method comprising contacting the fluid with a scrubbing medium that comprises (a) an aqueous solution of a base, and (b) a peroxide having at least one —O—OH group; under conditions sufficient to react at least a portion of the sulfuryl fluoride with the peroxide to form a sulfuryl fluoride byproduct.

2. The method of claim 1, wherein the fluid comprises air.

3. The method of claim 1, wherein the aqueous solution of the base has a pH of 7 or higher.

4. The method of claim 1, wherein the base is a water-soluble hydroxide of an alkali or alkaline earth metal, a carbonate, a bicarbonate, a phosphate, a pyrophosphate, or a borate.

5. The method of claim 4, wherein the base is sodium hydroxide, potassium hydroxide, sodium carbonate, potassium carbonate, sodium borate, or potassium borate.

6. The method of claim 1, wherein the peroxide is hydrogen peroxide, peroxyacetic acid, a peroxymonosulfate, or a peroxycarbonate.

7. The method of claim 1, wherein the peroxide is hydrogen peroxide.

8. The method of claim 1, wherein the peroxide is generated in the scrubbing medium from a precursor thereof.

9. The method of claim 8, wherein the precursor is a metal peroxide, a metal peroxycarbonate, or an adduct capable of liberating hydrogen peroxide in the scrubbing medium.

10. The method of claim 8, wherein the precursor is sodium perborate, calcium peroxide, magnesium peroxide, or urea peroxide.

11. The method of claim 1, wherein the peroxide is generated in situ in the scrubbing medium.

12. The method of claim 11, wherein the peroxide is generated electrochemically.

13. The method of claim 1, wherein the scrubbing medium further comprises a pH buffer.

14. The method of claim 13, wherein the pH buffer is a phosphate, a pyrophosphate, a carbonate, or a borate.

15. The method of claim 1, wherein the sulfuryl fluoride byproduct comprises a sulfur product and fluoride.

16. The method of claim 15, further comprising the step of precipitating the fluoride from the scrubbing medium.

17. The method of claim 16, comprising contacting the scrubbing medium with a metal salt to form a precipitated metal fluoride.

18. The method of claim 17, wherein the metal salt is calcium chloride or calcium hydroxide.

19. A kit for removing sulfuryl fluoride from a fluid in a scrubbing medium by forming a sulfuryl fluoride byproduct, the kit comprising:
a) a peroxide having at least one —O—OH group, or a precursor capable of generating the peroxide in the scrubbing medium;
b) a base in an amount effective to dissociate the proton from the at least one O—OH group in the scrubbing medium; and
c) optionally, one or more indicators capable of detecting amounts of the peroxide, the base, or the sulfuryl fluoride byproduct in the scrubbing medium.

20. The kit of claim 19, wherein the base is a water-soluble hydroxide of an alkali or alkaline earth metal, a carbonate, a bicarbonate, a phosphate, a pyrophosphate, or a borate.

21-27. (canceled)
